(19) United States
(12) Patent Application Publication
(10) Pub. No.: US 2012/0164494 A1
(43) Pub. Date: Jun. 28, 2012

(54) ELECTRODE COIL

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/322,119

(22) PCT Filed: May 25, 2010
(86) PCT No.: PCT/EP10/03173

§ 371 Date: Mar. 13, 2012

(30) Foreign Application Priority Data
May 26, 2009 (DE) 10 2009 022 678.8
Oct. 14, 2009 (EP) 09012982.6

(51) Int. Cl. H01M 10/04; H01M 10/50; H01M 2/16; H01M 4/485; H01M 4/505; H01M 4/525; H01M 2/02; H01M 4/70; B82Y 30/00

(52) U.S. Cl. 429/50; 429/94; 29/623.5; 977/773

(57) ABSTRACT

The invention relates to an electrode coil (3) having a substantially cylindrical shape, comprising at least: one anodic electrode (5), one cathodic electrode (6), and one separator (4) disposed at least partially between said electrodes (5, 6), characterized in that the separator (4) is produced from a material comprising at least one component made of a ceramic material.

The invention relates to an electrode coil according to the preamble of claim 1. The invention will be described within the context of a lithium ion battery for supplying power to a motor vehicle. It is noted that the invention can also be used independently of the chemistry and the design of the electrode coil, or the type of drive to which power is supplied.

In the prior art, electrode coils and/or galvanic cells are known which may release stored energy in an uncontrolled manner in the event of mechanical damage or if they become overheated. This can present a hazard to the environment.

The problem addressed by the invention is that of providing a safer design for an electrode coil or a galvanic cell comprising an electrode coil.

This problem is solved by an electrode coil having the features of claim 1. Preferred and advantageous further developments are the subject matter of the dependent claims. A preferred use of a galvanic cell comprising at least one electrode stack according to the invention is the subject matter of a subsidiary claim.

To solve the problem, an electrode coil which is substantially cylindrical in shape is proposed. The electrode coil has at least one anodic electrode, one cathodic electrode, and one separator. The separator is disposed at least partially between these electrodes. The electrode coil is characterized in that the separator is made of a material comprising at least one component made of a ceramic material.

Within the context of the invention, an electrode coil is understood as an equipment which is also used for storing chemical energy and for supplying electric energy, more particularly, as an assembly of a galvanic cell. Before electric energy is supplied, stored chemical energy is converted to electric energy. During charging, the electric energy that is supplied to the electrode coil or the galvanic cell is converted to chemical energy and stored. To this end, the electrode coil has a plurality of layers, at least one anode layer, one cathode layer and one separator layer. The layers are laid or stacked one on top of the other, wherein the separator layer is disposed at least partially between an anode layer and a cathode layer. The layers of the electrode coil are wound, particularly around a core. Starting from its base surface or end surface, the electrode coil extends perpendicularly along its longitudinal axis. The base surface of the electrode coil is preferably substantially circular or polygonal, particularly hexagonal. The corners of the base surface are preferably rounded.

Within the context of the invention, a galvanic cell is understood as a device which is also used for storing chemical energy and for supplying electric energy. For this purpose, the galvanic cell according to the invention is equipped with at least two electrodes and an electrolyte. More particularly, the galvanic cell can be configured for receiving electric energy during charging, converting this energy to chemical energy, and storing it. Thus it can also be characterized as a secondary cell or an accumulator.

Within the context of the invention, an anode layer or an anode is understood as an equipment which during charging receives electrons and/or positively charged ions, more particularly, inserting these on interstitial lattice sites. The anode is preferably embodied as thin-walled, and with particular preference, the thickness of the anode is less than 5% of its outer circumference. The anode preferably has a metal foil or a metallic network structure. The anode is preferably embodied as substantially rectangular.

Within the context of the invention, a cathode layer or a cathode is understood as an equipment which, during discharging or during the supplying of electric energy, also receives electrons and/or positively charged ions. The cathode is preferably embodied as thin-walled, and with particular preference, the thickness of the cathode is less than 5% of its outer circumference. The cathode preferably has a metal foil or a metallic network structure. The configuration of a cathode of the electrode coil preferably corresponds substantially to the configuration of an anode thereof. A cathode is also provided for electrochemical interaction with an anode or with the electrolyte.

Preferably, at least one electrode of the electrode coil, and particularly preferably at least one cathode, has a compound of the formula LiMPO₄, wherein M is at least one transition metal cation from the first row of the Periodic Table of Elements. The transition metal cation is preferably chosen from the group consisting of Mn, Fe, Ni and Ti, or a combination of these elements. The compound preferably has an olivine structure, preferably superordinate olivine.

In another embodiment, at least one electrode of the electrode coil, with particular preference at least one cathode, preferably comprises a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide, which contains manganese, cobalt and nickel. Within the context of the invention, a separator is also understood as an electrically insulating device, which separates and spaces an anode from a cathode. A separator layer is preferably applied to an anode and/or a cathode. The separator layer or the separator also at least partially absorbs an electrolyte, wherein the electrolyte preferably contains lithium ions. The electrolyte is also electrochemically actively connected to adjoining layers in the electrode stack. The shape of a separator preferably corresponds substantially to the shape of an anode of the electrode coil.

According to the invention, the separator (hereinafter “ceramic separator”) is made of a material, which comprises at least one component made of a ceramic material. The porosity of this ceramic material is sufficient for the functioning of the electrode coil, but as compared with polyolefin separators said material is substantially more temperature-resistant and shrinks less at higher temperatures. A ceramic separator also advantageously offers high mechanical stability. As the ceramic material, Al₂O₃ (aluminum oxide) and/or SiO₂ (silicon dioxide) is also preferably used. Depending upon the battery power that is required, ceramic separators of different thickness and/or porosity can be provided.

Because of the high currents present during operation of an electrode coil for supplying power to a motor vehicle drive, the electrode coil is also heated to high temperatures. A separator made of a polyolefin material can shrink significantly under excessive heat, for example, as a result of a short-circuit or overload, making the electrode coil at least unusable. Under a severe shrinkage effect, direct contact between the anodic electrode and the cathodic electrode also occurs, resulting in even greater overheating of the electrode coil, which can also ignite a fire. If the separator is made of a ceramic material, its temperature resistance in particular is increased, or the temperature-based shrinkage of the separator is reduced. Thus, the electrical separation of electrodes is largely maintained by way of a ceramic separator, particularly at higher temperatures. The risk of an uncontrolled discharging of the electrode coil is advantageously decreased, and the problem that is addressed is solved.

Advantageously, the ceramic separator is made of a flexible ceramic composite material. A composite material is produced from different materials, which are permanently bonded to one another. A material of this type can also be called a laminate material. More particularly, it is provided that this composite material is formed from ceramic materials and polymeric materials. It is known to provide a non-woven material made of PET with a ceramic impregnation and/or coating. Such composite materials can withstand temperatures greater than 200° Celsius (in some cases up to 700° Celsius). Preferably, the ceramic separator is wetted on one side with an ionic liquid. The ionic liquid particularly increases the flexibility of the ceramic separator. Preferably, the ceramic separator is wetted on two sides with an ionic liquid. Ionic liquids are particularly suitable for this purpose. These are adjusted so as to adhere to the ceramic separator, and are thereby able to wet said separator adequately, particularly with respect to the production thereof.

Advantageously, one separator layer or one separator extends at least in regions over a boundary edge of at least one particularly adjacent electrode. With particular preference, one separator layer or one separator extends across all boundary edges of particularly adjacent electrodes. In this manner, electric currents are also decreased between the edges of electrodes of the electrode coil.

Advantageously, the electrode coil comprises at least two electrode pairs, i.e., at least two anodes (a) and at least two cathodes (k). Electrodes of different polarity are also separated by means of at least one separator (s). Particularly, the layers of the electrode coil are arranged in the sequence a₁-s-k₁-s-a₂-s-k₂. These layers are wound to form an electrode coil. In this electrode coil, a plurality of electrode layers are preferably connected to one another, particularly in an electrically conductive manner. With an electrically conductive connection of electrodes of the same polarity, the electrode pairs are connected in parallel. With an electrically conductive connection of electrodes particularly of different polarity, the electrode pairs are preferably connected in series. Particularly, the electric voltage of the electrode coil is advantageously increased.

At least one contact element is advantageously disposed on at least one boundary surface of the electrode coil, and is connected to an electrode. Within the context of the invention, a boundary surface of an electrode coil is understood as one of its outer surfaces. Within the context of the invention, an end surface is also encompassed by the term “boundary surface”. Within the context of the invention, a contact element is understood as a conductive device, which particularly electrically contacts an electrode of the electrode coil, and particularly, projects out of the electrode coil or protrudes therefrom. Preferably, at least two contact elements are disposed, each on at least one boundary surface. In each case, at least one contact element is preferably disposed on each of different boundary surfaces of the electrode coil. Preferably, at least two contact elements are disposed on the same boundary surface of the electrode coil, particularly, on an end surface thereof. A plurality of contact elements are preferably assigned to one electrode layer of the electrode coil, more particularly, at a uniform distance. The current density of each contact element is thereby preferably reduced. One contact element is preferably embodied as an electrically conductive, flat element on a boundary surface of the electrode coil. One contact element is preferably embodied as a small conductor vane. At least two contact elements of different electrode layers are preferably electrically connected to one another, more particularly, for the series connection of the electrode layers. According to the invention, a separator is preferably used, which consists of a permeable carrier, preferably partially permeable, in other words, substantially permeable with respect to at least one material, and substantially impermeable with respect to at least one other material. The carrier is coated on at least one side with an inorganic material. As the permeable carrier, an organic material is preferably used, which is preferably embodied as a non-woven material. The organic material, preferably a polymer and more preferably polyethylene terephthalate (PET), is coated with an inorganic ion-conducting material, which is preferably ion-conducting within a temperature range of −40° C. to 200° C. The inorganic, ion-conducting material preferably comprises at least one compound from the group of oxides, phosphates, sulfates, titanates, silicates, aluminosilicates containing at least one of the elements Zr, Al, Li, and with particular preference, zirconium oxide. The inorganic, ion-conducting material preferably contains particles having a maximum diameter of less than 100 nm. A separator of this type is sold under the trade name “Separion” by Evonik A G in Germany, for example.

Advantageously, a galvanic cell has at least one electrode coil and one housing. Within the context of the invention, a housing is understood as an equipment, which especially separates the at least one electrode coil from the surrounding area. To this end, the housing encompasses the at least one electrode coil essentially completely by a wall. The housing is preferably adapted at least in sections to match the shape of an electrode coil. With preference, the housing is predominantly adapted to match the shape of an electrode coil. The housing is preferably adhesively connected, at least in sections, to the electrode coil. The housing is preferably embodied as a composite film. Preferably, the housing comprises a metal foil. The housing preferably rests predominantly on the electrode coil. Preferably, the housing surrounds the electrode coil at least partially in a positive connection, supports the electrode coil, and holds the layers thereof together. The housing is preferably pre-stressed and exerts a force on the electrode coil. The housing therefore forces the layers of the electrode coil against one another and advantageously minimizes any displacement of one layer of the electrode coil in relation to the remaining layers thereof. The housing is preferably embodied as a thin-walled metal sheet.

Advantageously, a galvanic cell comprises at least two electrode coils and one housing. The at least two electrode coils are preferably connected to one another, particularly electrically connected, particularly, in series. Preferably, the at least two electrode coils are disposed in relation to one another such that the longitudinal axes thereof extend substantially parallel to one another, and with particular preference coincide. Preferably, two electrode coils contact one another on each end surface. Preferably, at least two electrode coils are at least partially surrounded by a shared housing. In this case, the shared housing is embodied as described above.

Advantageously, at least one current conducting means is assigned to the interior of the housing. The current conducting means also serves to produce the active electric connection between two electrode coils, particularly for the series connection thereof. Preferably, the at least one current conducting means is provided for contacting at least one contact element in each electrode coil, particularly preferably for contacting at least one contact element of each of at least two electrode coils. The interior side of the housing preferably has a plurality of current conducting means, separated from one another, at the same time. Preferably, the at least one current conducting means is embodied as a conductor or current conducting surface, which is particularly applied to the interior side of the housing. The current conducting means is preferably applied by vapor deposition to the interior side of the housing. Preferably, the at least one current conducting means is embodied as a conductive plate, which is inserted during production of the housing. Preferably, the at least one current conducting means is embodied such that under predefined conditions, particularly above a predefined temperature, it will fail. The at least one current conducting means preferably has a thin section. Preferably, the at least one current conducting means is particularly electrically connected to a pole contact of the housing. At least one current conducting means preferably extends through the housing.

Advantageously, at least one contact element of an electrode coil is particularly electrically connected to one region of the housing. Preferably, at least one contact element of an electrode coil is particularly electrically connected in sections to the wall of the housing. This electrically conductive region of the wall preferably extends at least in the direction of one pole contact, in the direction of another electrode coil, and/or to the exterior side of the wall. This electrically conductive region of the wall of the housing serves particularly for the electrical contacting of at least one electrode coil. More particularly, via this electrically conductive region of the wall, two electrode coils are electrically connected to one another. This electrically conductive region of the wall of the housing preferably serves to produce the electrical connection of an electrode coil to a pole contact and/or to the surrounding area. Wiring within the galvanic cell can advantageously be dispensed with.

At least one contact element of an electrode coil is advantageously guided through the housing. This projecting contact element is used particularly for the electric contacting of the electrode coil. Preferably, the at least one contact element is guided gas-tight through the housing, more particularly, through the wall thereof. Preferably, at least two contact elements are guided through the housing.

The housing advantageously has at least one first connection region. This first connection region is used particularly for producing the connection of the housing to at least one other body, particularly, to another housing, to a region of the battery housing, and/or to a heat exchanger device. The housing preferably has a plurality of first connection regions. Preferably, the connection to at least one other body is embodied as adhesive and/or frictional.

Advantageously, the housing has at least one heat transfer area. The heat transfer area is preferably assigned to the wall of the housing. This heat transfer area serves particularly for transferring heat into an electrode coil or out of said coil. In this case, the electrode stack is connected, at least in areas, to the housing so as to conduct heat. The heat transfer area preferably extends across a majority of the wall of the housing. A first temperature control medium preferably flows past the heat transfer area, and/or said area is connected to a heat exchange device so as to conduct heat. Preferably, a first connection region and a heat transfer area at least partially coincide with one another.

The housing advantageously comprises at least two molded parts. These are provided to be connected to one another. The connection of at least two molded parts to one another is preferably frictional and/or adhesive. More particularly, depending on the materials used in the different molded parts, said parts are connected to one another by adhesive or by a welding process. More particularly, ultrasonic welding is used to connect a metallic molded part to a thermoplastic molded part. In this case, a pre-treatment or activation of at least one of the surfaces of an involved molded part is particularly expedient. Particularly, a frictional or adhesive connection connects the at least two molded parts in such a way that a continuous, strip-type connection preferably seals the space between the molded parts off from the surrounding area. Preferably, at least two molded parts are particularly adhesively connected to one another in a second connection area. This second connection area preferably extends along an edge region of an involved molded part. In this case, the second connection area is embodied in the form of a strip. It is not necessary for the second connection area to extend all the way along the boundary edges of the molded part. Before the involved molded parts are connected, additional inserted parts can be arranged in such a way that said parts are also connected frictionally or adhesively to the molded parts. At least one contact element of the electrode coil is preferably arranged such that it extends partially out of the housing. Preferably, the housing is also embodied as gas-tight in relation to the surrounding area, in the regions where a contact element passes through it.

At least one molded part of the housing preferably comprises a heat transfer area. The heat transfer area is preferably embodied to act at the same time as the first connection area. The heat transfer area can also be used for attaching the galvanic cell to a heat exchange device, more particularly, by screws, rivets, gluing or welding. Preferably, at least one molded part of the housing is designed as rigid. This molded part particularly provides support to the electrode coil, protects the electrode coil against mechanical damage and/or serves to produce the mechanical connection between the galvanic cell and a supporting device. A rigid molded part is preferably embodied as a metal plate or metal sheet. The molded part is preferably reinforced by beading, elevated areas and/or ribs. At least one molded part of the housing is preferably embodied as thin-walled. The wall thickness of a thin-walled molded part is preferably adapted to a mechanical, electric or thermal load. In that case, the wall thickness preferably is not uniform. One region of a thin-walled molded part having a greater wall thickness acts particularly as a heat sink or heat reservoir, and, more particularly, contributes to thermal energy being eliminated from or transported into the electrode coil. The thin-walled embodiment of a molded part also advantageously saves on weight and space. Preferably, at least one molded part is embodied as a film, with particular preference, as a composite film. Possible materials for the composite film include particularly metals and/or plastics. At least one molded part of the housing preferably has a coating, at least in some sections. This coating also serves to adapt the molded part to loads to which it is exposed. More particularly, the coating serves to provide electric insulation, to protect the molded part from the chemicals of the galvanic cell, to improve adhesion in the case of an adhesive connection, to improve thermal conductivity, and/or to protect particularly against damaging effects from the environment. Particularly, a coating effects a chemical activation of the surface of the molded part. A coating preferably comprises at least one material that is different from the materials of the molded part. The at least one molded part preferably also has a plurality of different coatings, which are particularly disposed on different areas of the molded part. When a molded part is in electric contact with the electrode coil, a conductor is preferably electrically insulated from said molded part.

Advantageously, at least one molded part of the housing comprises a recess, more particularly, a shell. This design particularly gives the molded part increased areal moment of inertia or bending stiffness. This recess preferably at least partially accommodates the electrode coil. This serves particularly to protect the electrode coil. The wall thickness of a molded part with a recess is preferably adapted to match the load. A plurality of molded parts of the housing each have at least one recess, which together form a space for accommodating the electrode coil. One molded part is preferably embodied as a deep-drawn or cold-extrusion pressed metal sheet. One molded part is preferably embodied as a deep-drawn plastic plate or plastic film. At least one molded part is preferably embodied as shell-shaped. In this case, the curvature of the shell-shaped molded part is adapted to match the radius of the electrode coil. If the base surface of the electrode coil is polygonal, at least one molded part extends over multiple surfaces along the longitudinal axis of the electrode coil. At least one molded part is preferably embodied as a cover.

Advantageously, at least one molded part has a first connection area. The first connection area serves particularly for attaching the galvanic cell, particularly in a housing, in a frame, or on a base plate. A first connection area is preferably embodied such that the relevant molded part can be connected to another body only in the predefined manner. For example, a first connection area has a geometric shape that corresponds to an area of another body. Preferably, a connection between the molded part and the other body is possible only in a predefined manner, by means of a configuration of molded elements, more particularly, holes and pins. The configuration of through holes or threaded openings preferably permits a connection only in a predefined manner. Preferably, a first connection area is spatially separated from a second connection area. At least one molded part of the housing preferably has a plurality of separate first connection areas. Particularly, the molded part is connected to another body by means of rivets, screws, welding or gluing. A first connection area of a molded part and a heat transfer area of the same molded part preferably coincide. In these areas, the molded part is particularly connected to a heat exchange device, to a frame, or to a base plate of the battery housing.

A battery advantageously comprises at least two galvanic cells, which are preferably electrically connected to one another, particularly, series connected. The battery is preferably assigned at least one heat exchange device, which is particularly thermally conductively connected to at least one of the at least two galvanic cells. The heat exchange device is provided for the purpose of exchanging thermal energy with at least one of the at least two galvanic cells under predefined conditions. These predefined conditions are satisfied particularly when the temperature of an electrode coil or of a galvanic cell exceeds or drops below a threshold temperature. More particularly, when the temperature of an electrode coil or of a galvanic cell approaches a minimum temperature or drops below said temperature, the heat exchange device supplies thermal energy to this electrode coil or to this galvanic cell. Particularly, when the temperature of an electrode coil or of a galvanic cell approaches a maximum temperature or exceeds said temperature, the heat exchange device draws thermal energy out of this electrode coil or out of this galvanic cell. In this case, a threshold temperature is chosen on the basis of the permissible operating temperatures of an electrode coil, more particularly, taking into consideration the thermal capacity of the housing and/or the location of temperature measurement. The battery preferably has at least one measuring device, which is provided particularly for detecting the temperature of at least one electrode stack or at least one galvanic cell. Preferably, the measuring device has a plurality of measuring sensors, which are provided particularly for detecting the temperature of a plurality of electrode stacks or a plurality of galvanic cells. The temperature of the heat exchange device is preferably chosen on the basis of the temperature of the electrode coil of a galvanic cell. A predetermined temperature gradient causes a flow of heat into this electrode coil or out of this electrode coil. In this connection, the heat exchange device exchanges thermal energy with an electrode coil via at least one region of the housing or the heat transfer area thereof, which is in contact with the heat exchange device. The galvanic cells that are present are also connected particularly frictionally or adhesively via a first connection area of the housing to the at least one heat exchange device. Advantageously, the heat exchange device has at least one first channel, particularly for adjusting a predefined temperature. This channel is preferably filled with a second temperature control medium. With particular preference, a second temperature control medium flows through this at least one channel. In this case, the flowing second temperature control medium supplies thermal energy to or removes thermal energy from the heat exchange device. The at least one heat exchange device is preferably actively connected to a heat exchanger. The heat exchanger draws thermal energy out of this heat exchange device, or supplies thermal energy to this heat exchange device, particularly by means of a second temperature control medium. The heat exchanger and/or the temperature control medium interact particularly with the air conditioning system of a motor vehicle. The heat exchanger preferably has an electric heating apparatus.

The heat exchange device is preferably embodied as a supporting device, more particularly, as a base plate or frame, for the at least two galvanic cells of the battery.

The longitudinal axes of the at least two galvanic cells are advantageously spaced a predefined distance from one another. Preferably, the longitudinal axes are parallel to one another. The distance between the longitudinal axes is preferably dimensioned such that the housings of the at least two galvanic cells touch. Preferably, the distance between the longitudinal axes of two adjacent galvanic cells is dimensioned such that said cells exert a force on a heat exchange device lying between them. This force serves particularly to improve the thermal contact between at least one galvanic cell and a heat exchange device. If the battery has at least three galvanic cells, the longitudinal axes thereof are preferably arranged parallel to one another. The distances between these longitudinal axes are determined by three predefined distance vectors. These distance vectors preferably lie within a shared plane. The values of the three distance vectors are preferably equal. With this arrangement of the galvanic cells, a heat exchange device is preferably positioned within the space between the three galvanic cells. The distances between the longitudinal axes of the galvanic cells are dimensioned such that the galvanic cells exert a force on the heat exchange device. The galvanic cells are preferably arranged on the basis of a square. In this case, the longitudinal axes of four galvanic cells form the corners of this square. Whereas the amount of space required is decreased in relation to a triangular unit cell, the heat exchange device is preferably embodied as larger and/or as having a higher capacity. The galvanic cells are preferably embodied as prismatic, wherein the base surface, more particularly, of the housing, is configured as a regular hexagon. With this embodiment of the galvanic cells, the heat exchange device is preferably embodied as a sheet that is canted at least once. At least one heat exchange device embodied in this manner is preferably inserted into an arrangement of prismatic galvanic cells. Preferably, a heat exchange device embodied in this manner has at least one channel, particularly for a second temperature control medium. During operation of the battery, this second temperature control medium preferably passes through a phase passage. The second temperature control medium is preferably conveyed by a conveyor apparatus through the at least one channel of the heat exchange device. Preferably, at least one channel in a heat exchange device is closed and filled with a second temperature control medium, which passes through a phase passage within the operating temperatures of the galvanic cells. The heat exchange device preferably also comprises at least one cooling body with an enlarged surface. The heat exchange device is preferably embodied as a heat pipe. A first temperature control medium preferably flows to the heat exchange device.

It is preferably provided that a lithium ion battery according to the invention is used for a motor vehicle having an electric drive or a hybrid drive.

The method according to the invention for producing an electrode coil according to the invention comprises the following steps:
a) Wetting or impregnating both sides of this (ceramic) separator with an ionic liquid;
b) Positioning this (ceramic) separator between an anodic electrode and a cathodic electrode;
c) Winding this arrangement to form an electrode coil.

The separator must be prepared prior to step a). The separator and the electrodes are preferably cut to size prior to step b). The assembly of ceramic separator and electrodes, after being wound into an electrode coil, is preferably accommodated in a housing, in order particularly to prevent the ionic liquid from flowing out or being liberated. It is preferably provided that the wetted or impregnated ceramic separator is applied or laminated onto an electrode, wherein the separator is preferably embodied to project beyond the electrode edge. The mechanical connection between the separator and an electrode is based upon adhesion. Laminating within the context of the invention is understood as joining with the application of pressure. As the ceramic separator is being applied, chemical additives are preferably added and/or heat is preferably applied. It is preferably provided that for wetting, ionic liquids with additives are used, which will wet the ceramic separator and enable processing under normal climatic conditions. More particularly, combining a ceramic separator with an ionic liquid with the two being matched to one another allows new processing methods to be used. Thus, for example, an inert gas environment or an anhydrous environment (air humidity<2%), and clean room conditions (atmospheric quality<30 ppm), as must be provided in inert gas boxes according to the prior art, are no longer required. Therefore, an electrode coil according to the invention can be produced in an energy-saving and cost-effective manner. According to a further aspect of the invention, it is provided that the ceramic separator becomes flexible and therefore processable only after a wetting solution, possibly containing additives, is applied, wherein said additives are particularly an ionic fluid. The wetting solution, including the possible additives, then is not removed, and is instead integrated into the electrode coil. The method according to the invention can therefore be easily executed, and is therefore also particularly suitable for automated series production.

Advantageously, a battery having at least two galvanic cells and one heat exchange device is operated such that the temperature of the at least one heat exchange device is adjusted on the basis of the temperature of at least one of the two galvanic cells. Preferably, the temperature of the at least one heat exchange device is adjusted on the basis of the permissible operating temperatures of the at least two galvanic cells. If the temperature drops below a minimum temperature or if the temperature of at least one galvanic cell approaches this minimum temperature, the temperature of the at least one heat exchange device is adjusted to above the temperature of the galvanic cell. Thus, a flow of heat is advantageously forced into the galvanic cell. If the temperature of at least one galvanic cell or one electrode coil approaches a maximum permissible temperature, the temperature of the heat exchange device is preferably selected to be lower than the temperature of the at least one galvanic cell. Thus thermal energy is drawn out of the galvanic cell or the electrode coil.

In this, a first temperature control medium preferably flows up to and/or flows through the at least one heat exchange device. The coolant of the motor vehicle air conditioning system preferably serves as the temperature control medium for the heat exchange device. The temperature of the first temperature control medium is preferably adjusted on the basis of the permissible operating temperatures of the at least two galvanic cells. If the temperature drops below a minimum temperature, or if the temperature of at least one galvanic cell approaches this minimum temperature, the temperature of the first temperature control medium is adjusted to above the temperature of the galvanic cell. Thus, a flow of heat is advantageously forced into the galvanic cell. If the temperature of a galvanic cell or of an electrode coil approaches a maximum permissible temperature, the temperature of the first temperature control medium is preferably selected to be lower than the temperature of the at least one galvanic cell. Thus thermal energy is drawn out of the galvanic cell or the electrode coil.

Advantageously, a first temperature control medium flows at least intermittently up to and/or through the at least one heat transfer area of a galvanic cell. Preferably, the ambient air and/or the first temperature control medium of the air conditioning system of the motor vehicle is used to flow up to and/or through the heat transfer area. The temperature of at least one heat transfer area is preferably adjusted on the basis of the permissible operating temperatures of the at least two galvanic cells. When the temperature drops below a minimum temperature, or when the temperature of at least one galvanic cell approaches this minimum temperature, the temperature of the at least one heat transfer area is adjusted to above the temperature of the galvanic cell. Thus, a flow of heat is advantageously forced into the galvanic cell. If the temperature of a galvanic cell or of an electrode coil approaches a maximum permissible temperature, the temperature of the at least one heat transfer area is preferably chosen to be lower than the temperature of the at least one galvanic cell. Thus thermal energy is drawn out of the galvanic cell or the electrode coil.

Additional advantages, features and possible uses of the present invention are presented in the following description of an embodiment example, in reference to the drawings. The drawings show:

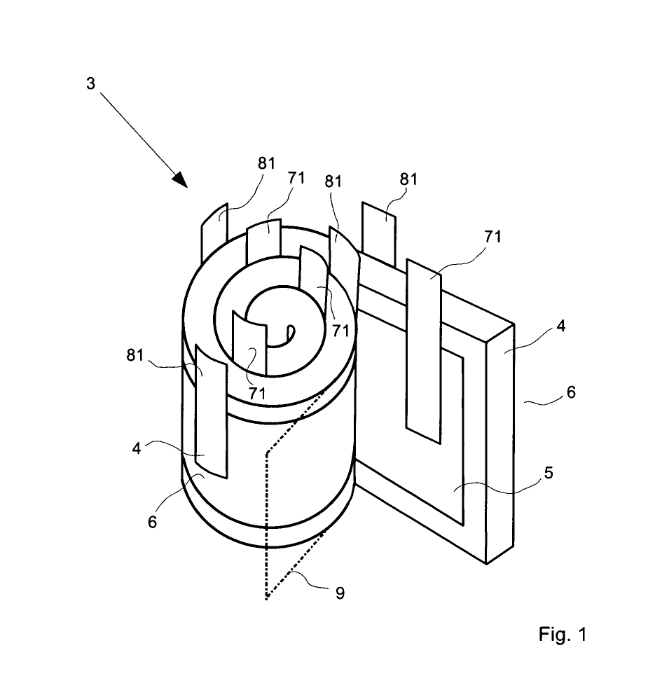

FIG. 1 an electrode coil according to the invention from a perspective view,

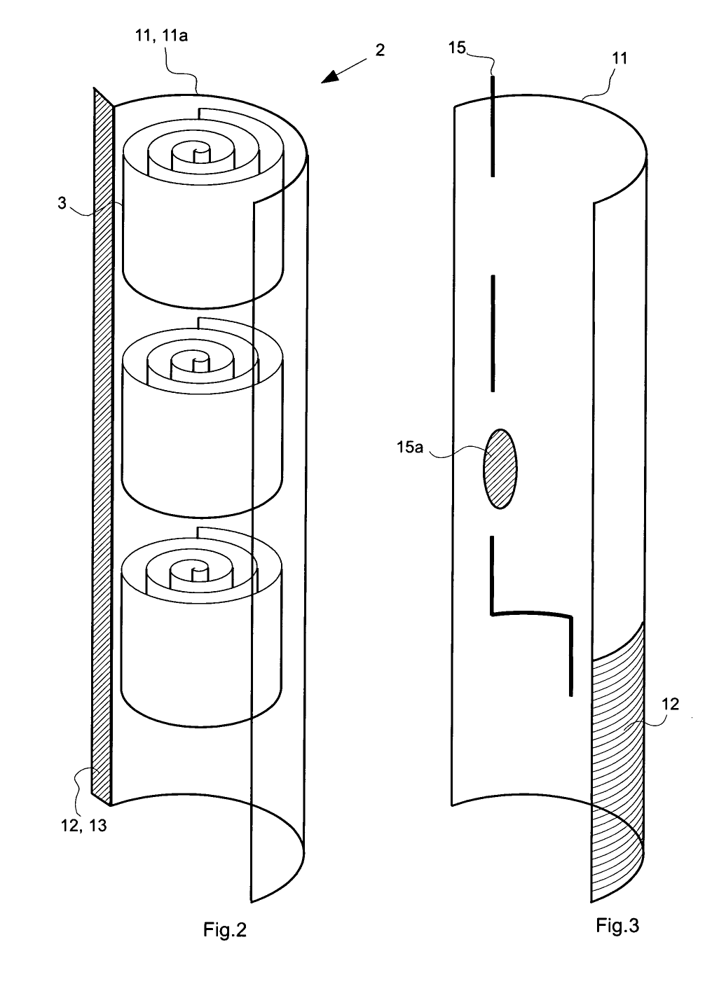

FIG. 2 a galvanic cell according to the invention, comprising a plurality of electrode coils according to the invention in a shared housing, in a schematic sectional detail view,

FIG. 3 a schematic illustration of a sectional view of a housing for a galvanic cell according to the invention,

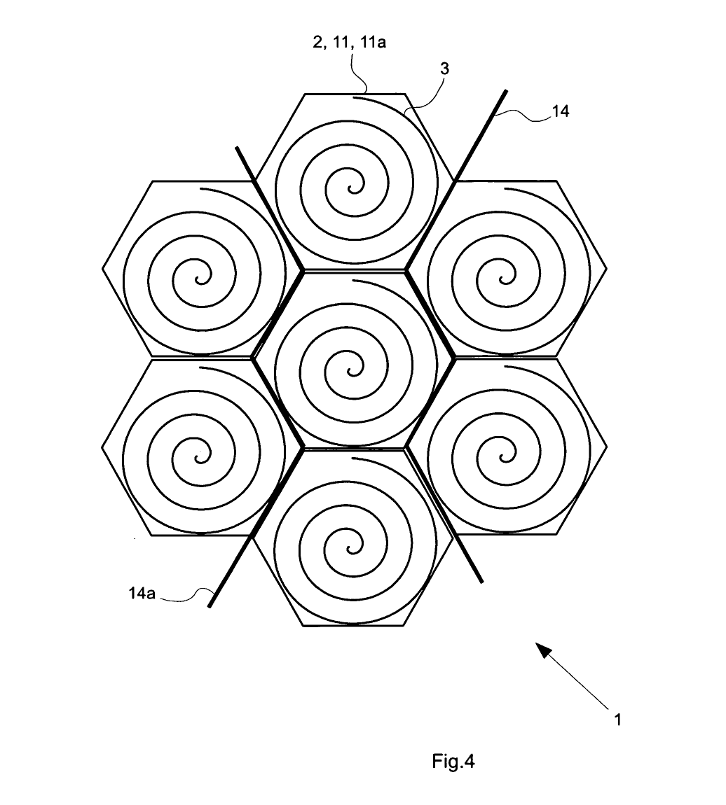

FIG. 4 a schematic illustration of an arrangement of a plurality of galvanic cells according to the invention with a heat exchange device,

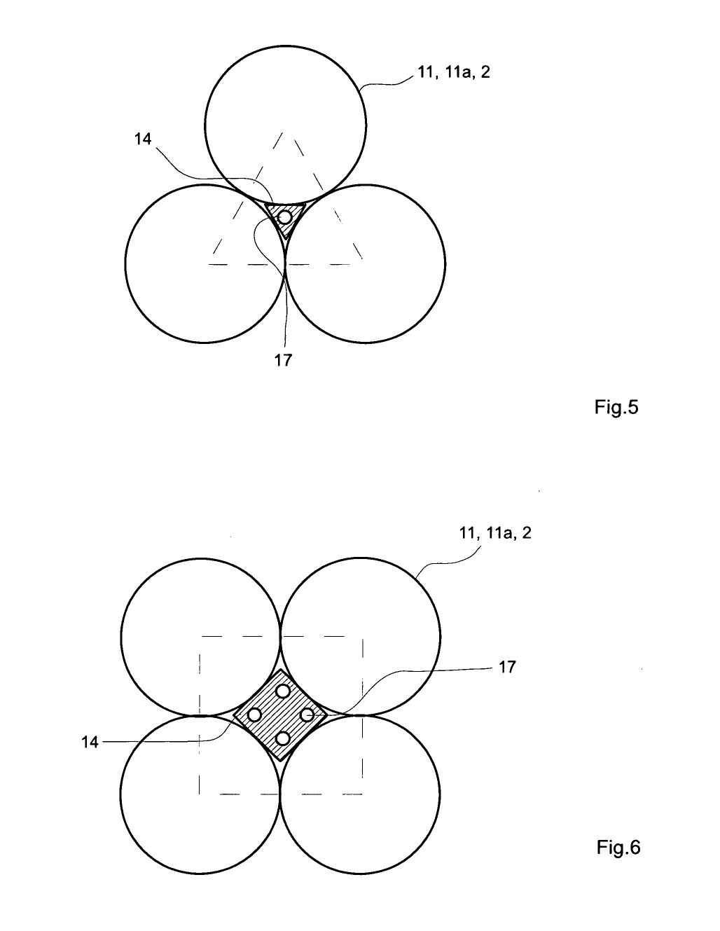

FIG. 5 a schematic illustration of another arrangement of a plurality of galvanic cells according to the invention with a heat exchange device,

FIG. 6 a schematic illustration of another arrangement of a plurality of galvanic cells according to the invention with a heat exchange device.

FIG. 1 illustrates an electrode coil 3 according to the invention from a perspective view. This drawing shows the electrode coil 3 before winding has been fully completed.

The electrode coil 3 comprises a ceramic separator 4, an anodic electrode 5 and a cathodic electrode 6. The separator 4 is embodied such that it projects beyond the outer edge or the outer outline of the electrodes 5 and 6, thereby particularly improving the chemical and electric stability of the electrode coil 3. More particularly, an ionic liquid is located between the separator 4 and the electrodes 5 and 6 disposed on both sides.

The electrodes 5 and 6 have contact elements or small arrester vanes 71 and 81, which are electrically connected to a pole feedthrough, not shown here. To improve the introduction of current and the removal of current from the electrode coil 3, a plurality of contact elements 71 and 81 are provided, which project out of the end surface of the electrode coil. In this manner, a plurality of electrode layers can also be disposed or accommodated in the electrode coil 3. This deliberately makes allowance for the fact that this plurality of contact elements 71 and 81 makes the production of an electrode coil 3 of this type more difficult. In this case, the contact elements 71 and 81 are disposed on an end surface of the electrode coil 3.

The electrode coil 3 is accommodated in a housing or a casing, not shown here. Contacting with the outside is implemented particularly by means of at least one pole feedthrough.

Irrespective of this, the battery cell 3 can also be disposed inside a separate covering (not shown). A covering of this type can also prevent the electrodes 5 and 6 disposed on the opposite sides of the separator 4 in the coil assembly from coming into electric contact with one another. To prevent such electric contact, an insulating layer 9 can also be alternatively and/or supplementally wound into the coil assembly, as indicated in the drawing by a dashed line. An insulating layer of this type is preferably also formed from a ceramic material, but can also be made of another thermally stable and electrically non-conductive material.

FIG. 2 schematically illustrates a galvanic cell 2 comprising a plurality of electrode coils 3, which are disposed in a shared housing 11. Not illustrated here are the contacts at the boundary surfaces of the electrode coil, a plurality of current conducting means 15 on the interior side inside the housing 11, and the pole contacts for the galvanic cell 2. Also not illustrated are second molded parts 11b for sealing the housing or the first molded part 11a. The electrode coils 3 are connected in series. The first molded part 11a is embodied as a metal sheet that is adapted to the shape of the electrode coils 3. The interior side of the molded part 11a is thermally conductive in areas, and at the same time is coated so as to be electrically insulating. The housing 11 and/or the first molded part 11a have a heat transfer area 12, which at the same time serves as a connection area 13. Depending upon the mode of operation, a first temperature control medium flows around the heat transfer area 12, or said area is connected to a heat exchange device.

FIG. 3 illustrates a section of a housing 11 for a galvanic cell. The housing 11 is embodied as a composite film. This composite film encompasses the electrode coils, not shown, with pre-stressing, and therefore, the housing 11 exerts a force on the electrode coils. This force presses the electrode coils together and against one another. A plurality of current conducting means 15, 15a are applied to the interior side of the housing 11. The current conducting means 15 is embodied as a current conducting tape, and is guided through the walls of the housing 11. The current conducting means 15 also serves for contacting the galvanic cell from the outside and for contacting an electrode coil. The current conducting means 15a is embodied as a metallic plate, which is connected to the interior side of the housing 11. The current conducting means 15a can preferably be electrically contacted both from the interior side of the housing 11 and from the outside. A pole feedthrough and/or a pole contact for the galvanic cell can thereby be advantageously dispensed with. The current conducting means 15a is embedded gas-tight into the composite film of the housing 11. The housing 11 has a heat transfer area 12.

FIG. 4 illustrates a battery 1 in cross-section. The illustrated battery 1 has seven galvanic cells 2. The housings 11 thereof are essentially prismatic in shape, and have a hexagonal base surface. The housing 11 or the first molded part 11a is formed from a metal sheet, which is coated in sections on the interior side so as to be electrically insulating and thermally conductive. The housing 11 surrounds the electrode coil 3 in such a way that the housing 11 exerts a force on the electrode coil 3. It is not shown that a galvanic cell 2 contains four electrode coils, which are connected in series. The battery 1 is further equipped with two heat exchange devices 14, 14a. The distances between the longitudinal axes of the individual galvanic cells are dimensioned such that the galvanic cells exert forces on the heat exchange devices 14, 14a. It is not shown that a temperature control medium flows up to the heat exchange devices 14, 14a. It is not shown that the first molded parts 11a are sealed by matching second molded parts embodied as covers. The heat exchange devices 14, 14a are bent multiple times, in order to enable, particularly, a space-saving arrangement of the galvanic cells 2, and to place large surfaces of the galvanic cells 2 in thermally conducting contact.

FIG. 5 shows an assembly of three galvanic cells with predefined distances between the longitudinal axes thereof. The elemental cell of the assembly is shown by a dashed line in the shape of an equilateral triangle. The open space between the galvanic cells 2 is filled by a heat exchange device 14. The heat exchange device 14 has a channel 17 for a temperature control medium. It is not shown that the heat exchange device 14 is adapted to match the shape of the surrounding galvanic cells 2. Thus the heat exchange device 14 is adapted over the largest possible surfaces to the galvanic cells 2. The heat exchange device 14 has a channel 17 for a second temperature control medium. The second temperature control medium is conveyed through the channels 17 by a conveyor device assigned to the battery 1. The second temperature control medium is selected such that it undergoes a phase transition at a temperature of three Kelvin below the maximum permissible operating temperature for the galvanic cell.

FIG. 6 also shows an assembly of a plurality of galvanic cells 2 around a shared heat exchange device 14. This heat exchange device 14 is adapted over the largest possible surfaces to the galvanic cells 2 that surround it. The heat exchange device 14 has a plurality of channels 17, which are provided for filling with a second temperature control medium. It is not illustrated that the channels 17 are sealed, and at their ends have a cooling body with an enlarged surface. The heat exchange device 14 acts together with the enlarged-surface cooling body and the second temperature control medium with a capacity for phase change as a heat pipe. For this purpose, it is necessary for the temperature of a phase passage for the second temperature control medium to be adapted to match the operating temperatures of the galvanic cells. The second temperature control medium is selected such that a phase change temperature lies five degrees Kelvin below the maximum permissible operating temperature of the galvanic cells 2 or of the electrode coil. In the drawing, the square elemental cell of the arrangement of longitudinal axes of the galvanic cells 2 is indicated by a dashed line. In comparison with FIG. 5, the volume utilization is somewhat diminished, however, the heat exchange device 14 is embodied as having larger surfaces and additional channels 17.

1.-16. (canceled)

17. An electrode coil (3) having a substantially cylindrical shape, which comprises at least:
one anodic electrode (5),
one cathodic electrode (6), and
one separator (4), which is disposed at least partially between these electrodes (5, 6),
a separator (4) made of a material, at least one component of which is made of a ceramic material, characterized in
that at least one electrode (5, 6) comprises a compound having an olivine structure.

18. The electrode coil according to claim 17, wherein an electrode (5, 6) comprises a compound of the formula LiMPO4 having an olivine structure, wherein M is at least one transition metal cation from the first row of the Periodic Table of Elements.

19. The electrode coil according to claim 18, wherein the transition metal cation is selected from the group consisting of Mn, Fe, Ni and Ti, or a combination of these elements.

20. The electrode coil according to claim 19, wherein at least one electrode (5, 6), which comprises a compound having an olivine structure, is a cathode (6).

21. The electrode coil according to claim 20, wherein it involves a superordinate olivine.

22. The electrode coil according to claim 21, wherein it comprises at least one electrode (5, 6), at least one cathode (6), which comprises a lithium manganate, LiMn2O4 of the spinel type, a lithium cobaltate, preferably LiCoO2, or a lithium nickelate, LiNiO2, or a mixture of two or three of these oxides, or a lithium mixed oxide which contains manganese, cobalt and nickel.

23. The electrode coil (3) according to claim 17, wherein the separator (4) is formed from a flexible ceramic composite material and/or in that the separator (4) is wetted at least on one side and on two sides with an ionic liquid.

24. The electrode coil (3) according to claim 23, wherein the separator (4) projects outward beyond the electrodes (5, 6) at least on one end surface of the electrode coil (3).

25. The electrode coil (3) according to claim 24, wherein the electrode coil (3) comprises at least two pairs of electrodes (5, 6) of different polarity, which are particularly connected in series.

26. The electrode coil (3) according to claim 25, wherein at least one contact element (71, 81) is disposed on at least one boundary surface of the electrode coil (3), on one end surface of the electrode coil (3).

27. The electrode coil (3) according to claim 26, wherein the separator (4) consists of a permeable substrate, substantially permeable with respect to at least one material and substantially impermeable with respect to at least one other material,
wherein the substrate is coated on at least one side with an inorganic material,
wherein an organic material is used as the permeable carrier, which is embodied as a non-woven material,
wherein the organic material comprises a polymer, and comprises polyethylene terephthalate (PET),
wherein the organic material is coated with an inorganic ion-conducting material, which is ion-conducting within a temperature range of from −40° C. to 200° C.,
wherein the inorganic, ion-conducting material is at least one compound from the group of oxides, phosphates, sulfates, titanates, silicates, and aluminosilicates of at least one of the elements Zr, Al, Li, and wherein the inorganic, ion-conducting material has particles having a maximum diameter of less than 100 nm.

28. A galvanic cell (2) comprising at least one electrode coil (3) according to claim 17, wherein the at least one electrode coil (3) is at least partially encompassed by a housing (11).

29. A galvanic cell (2) comprising at least two electrode coils (3) according to claim 17, wherein the at least two electrode coils (3) are electrically connected to one another, in that the longitudinal axes of the at least two electrode coils (3) are arranged substantially parallel with one another, and in that the at least two electrode coils (3) are surrounded at least partially by a shared housing (11), wherein at least one current conducting means (15, 15a) is preferably assigned to the interior side of the housing (11).

30. The galvanic cell (2) according to claim 29, wherein at least one contact element (71, 81) of an electrode coil (3) is particularly electrically connected to the housing (11), or in that at least one contact element (71, 81) of an electrode coil (3) is guided out of the housing (11).

31. The galvanic cell (2) according to claim 30, wherein the housing (11) comprises at least one first connection area (13) and/or at least one heat transfer area (12), or in that the housing (11) comprises at least one first molded part (11a) and one second molded part (11b), which are provided for connection to one another.

32. A battery (1) comprising at least two galvanic cells (2) according to claim 31, wherein the battery (1) is assigned at least one heat exchange device (14, 14a), which is provided for exchanging thermal energy with at least one of the at least two galvanic cells (2) under predefined conditions, wherein the longitudinal axes of the at least two galvanic cells (2) have a predefined distance from one another.

33. A use of a galvanic cell (2) according to claim 32 for a motor vehicle having an electric drive or a hybrid drive.

34. A method for producing the electrode coil (3) according to claim 17, comprising the following steps:
a) wetting or impregnating a separator (4) on both sides with an ionic liquid;
b) arranging the separator (4) between an anodic electrode (5) and at least one cathodic electrode (6)
c) winding this assembly to form an electrode coil (3).

35. A method for operating a battery (1) comprising at least two galvanic cells (2) according to claim 32, and at least one heat exchange device (14, 14a), wherein the temperature of the at least one heat exchange device (14, 14a) is adjusted on the basis of the temperature of at least one of the two galvanic cells (2), wherein a first temperature control medium flows at least intermittently up to and/or through the heat exchange device (14, 14a), wherein the temperature of the first temperature control medium is adjusted on the basis of the temperature of at least one of the two galvanic cells (2).

36. The method for operating a galvanic cell (2) according to claim 35, wherein a first temperature control medium at least intermittently flows up to and/or through at least one heat transfer area (12).
